(19) United States
(12) Patent Application Publication
(10) Pub. No.: US 2007/0033080 A1
(43) Pub. Date: Feb. 8, 2007

(54) Method and apparatus for process discovery related applications

(75) Inventors: Alon Hochberg, Ramat Aviv (IL); Vladimir Morgenstern, Framingham, MA (US)

Correspondence Address: DAVIDSON, DAVIDSON & KAPPEL, LLC, 485 SEVENTH AVENUE, 14TH FLOOR, NEW YORK, NY, 10018, US

(73) Assignee: Prolify Ltd., Netanya (IL)

(21) Appl. No.: 11/369,675

(22) Filed: Mar. 7, 2006

Related U.S. Application Data
(63) Continuation of application No. 10/551,353.

(51) Int. Cl. G06F 9/44

(52) U.S. Cl. 705/7

(57) ABSTRACT

A method for discovering activities or processes within an organization, to be used in a process management and control system, the method comprising the steps of importing one or more actions associated with one or more planned or active projects within the organization, identifying one or more activities from the actions, and updating a pattern library based on the activity.

### RELATED APPLICATIONS

The present application claims priority from U.S. patent application Ser. No. 10/551,353, titled APPARATUS AND METHODS FOR PROCESS AND PROJECT MANAGEMENT AND CONTROL, filed 28 Sep. 2005, and from PCT International patent application serial number PCT/IL2005/000833 titled APPARATUS AND METHODS FOR PROCESS AND PROJECT MANAGEMENT AND CONTROL, filed 4 Aug. 2005, both applications incorporated herein by reference.

### BACKGROUND OF THE INVENTION

1. Field of the Invention

The present invention relates to processes within an organization in general, and to a method and apparatus for automatic discovery of processes in particular.

2. Discussion of the Related Art

Many systems, for example the system described in International patent application serial number PCT/IL2005/000833 titled APPARATUS AND METHODS FOR PROCESS AND PROJECT MANAGEMENT AND CONTROL, filed 4 Aug. 2005, which are designed to be used in process management tasks within organizations, and especially large organizations, suffer from a blockage during deployment time. Such systems can detect and identify behaviors, and risks emerging from such behaviors, based on preliminary knowledge about the processes within the organization. For example, the apparatus described in PCT/IL2005/000833 recognizes known behavioral patterns and risks associated with deviations from such patterns within an organization. However, such systems, including the described apparatus require an efficient and economic method and apparatus for introducing the relevant and correct patterns of behavior into the apparatus, in order to achieve fast and seamless integration of the process management apparatus to the organization. However, when a process management system serves a specific organization rather than a general purpose such as accounting, the system might have to adapt to and accommodate the procedures and processes common in the organization. Before knowledge of such procedures and processes is available, the system's performance may not fulfill the expectations. Obtaining such knowledge can be done by the system developers, or by another entity, which would tailor the solution specifically for each customer, or for each market segment. However, this solution is lengthy, costly and risky, since the person qualified to enhance the system is usually not a domain expert, and would not necessarily take into account all of the organization's activities and needs. Alternatively, a professional can work with a domain expert, such as a person who knows the organization inside out. However, this solution is not ideal either, since it requires time and attention resources from the domain expert, in addition to the time and cost of the professional. In yet another alternative, the system can be equipped with a user interface that enables users to make their own adjustments and definitions, by describing their procedures and needs to the system. This solution is still not complete, because a user, when not naturally doing the on-going job but rather trying to describe it, might not predict or remember all the possible cases and procedures, and might also use the system in sub-optimal ways due to insufficient knowledge. In addition, a busy user will tend to delay such non-urgent tasks, or do them offhandedly in order to free more time for urgent issues.

There is therefore a need for a method and apparatus that will enable the adaptation of a process management system to work within a specific organization. The result of the adaptation should provide the process management system with clear and precise information about processes within the organization, their significance, the interrelationships between processes, and the associated risks while consuming minimum time, effort and expenses.

### SUMMARY OF THE PRESENT INVENTION

It is an object of the present invention to provide a novel apparatus and method for discovering activities or processes within an organization, to be used in a process management and control system. In accordance with the present invention, there is thus provided a method for discovering one or more activities or processes within an organization, the method comprising the steps of receiving one or more process maps, each process map comprising one or more actions associated with one or more active projects or planned projects, and identifying one or more activities or processes from the process maps. The method can further comprise a step of updating one or more pattern libraries, based on the activities or processes, or a step of updating the process maps. The one or more actions can be created from an e-mail message, or from a user reporting the action, or from a requirements management system, or from an update in a spreadsheet. The activity can be presented as one or more patterns. Within the method, the activity can be a basic activity. Within the method identifying the activities or the processes can comprises the steps of generating a task list comprising one or more tasks, a task having a task type and representing an activity; grouping the tasks according to the task type into one or more groups, each groups representing the activity; and selecting one or more groups by a user. Within the method, the activity can be a composite activity. The method can further comprise a step of identifying one or more key deliverables, or one or more milestones. The method can further comprise a step of identifying one or more activity groups, a step of splitting an activity group into at least two activities, a step of selecting one or more activities by a user from a list of activities, or a step of adding a standard activity library. The method can further comprise the steps of determining a metrics for associating a cost with one or more practices, and identifying one or more practices having an optimal cost within the organization. The method can further comprise an on-going stage for constructing, controlling or managing one or more processes based on the process maps. The method can be used simultaneously with or after the on-going stage. The on-going stage can use the process map.

Another aspect of the disclosed invention relates to an apparatus for discovering one or more activities or processes within an organization, the apparatus comprising one or more interface components, one or more activity identification components; one or more management component, and an activity data structure construction component. The apparatus can further comprise a metrics determination component, or a task identification and grouping component. The interface component can be an organizational interface component, which can capture information from one or more e-mail messages. Within the apparatus, the data structure can be a process map, the process map can comprise one or more patterns.

Yet another aspect of the disclosed invention relates to a computer readable storage medium containing a set of instructions for a general purpose computer, the set of instructions comprising receiving one or more process maps, each process map comprising one or more actions associated with one or more active projects or planned projects, and identifying one or more activities or one or more processes from the process maps.

### BRIEF DESCRIPTION OF THE DRAWINGS

The present invention will be understood and appreciated more fully from the following detailed description taken in conjunction with the drawings in which:

FIG. 1 is an exemplary environment in which the disclosed apparatus is used;

FIG. 2 is an overall scheme showing the integration of the discovery stage and the on-going stage of a process management system, in accordance with a preferred embodiment of the disclosed invention;

FIG. 3 is a flowchart showing the main steps associated with data collection step, data structure building step, and new activities identification step, in accordance with a preferred embodiment of the disclosed invention; and

FIG. 4 is a block diagram showing the main components in the proposed apparatus, in accordance with a preferred embodiment of the disclosed invention.

### DETAILED DESCRIPTION OF THE PREFERRED EMBODIMENT

The present invention overcomes the disadvantages of the prior art by providing a novel method and a system which include a step of process and activity discovery, thus enhancing and adding to the capabilities of a process management and risk analysis method and apparatus. The discovery step is to be used simultaneously with or off-line from a process management system working in an n on-going mode. As disclosed in International patent application serial number PCT/IL2005/000833 titled APPARATUS AND METHODS FOR PROCESS AND PROJECT MANAGEMENT AND CONTROL, filed 4 Aug. 2005, the process management system constructs and maintains, preferably over a period of time preferably ranging from a few days to years, a data structure, such as a process map, representing current processes and activities occurring in an organization. The system tries to identify within the data structure one or more known patterns, said patterns representing known activities, processes, behaviors or best practices relevant o the organization. Once one or more such patterns are found, the system either tries to adapt the organizational behavior to comply with the patterns, or issues an alert about the deviation. Examples for activities or processes which occur within an organization are issuing a new version of a product, receiving a certificate for a product, integrating an external component into a product or the like. The disclosed method and apparatus learn via a discovery process or stage, the processes occurring within the organization from observation of the data collected in relation to actual processes occurring in the system, with or without the workflow management system being deployed. The discovery process will thus enhance and adapt to the specific organization the group of known patterns which are searched for in the data structure representing the activities within the organization, such as the process map. Optionally, the system and method enhance also the current data structure, representing the current processes occurring within the organization. When the system is in discovery mode, the user generally works with the process and workflow management system in an uninterrupted manner, or provides minimal indications to the system about processes he or she are involved with, while the system studies the behaviors, patterns and procedures within the organization. The system generally learns about the activities from actions of users within the organization, mainly e-mails, but other information channels can also be used, such as faxes, instant messages, web browsing and others. Activities can also be reported by a user, or created from interfaces with systems such as Quality Center, a requirements management system by Mercury Interactive Corporation, or others. The learning is preferably accompanied by importation and introduction of externally generated activities and behaviors. During the discovery step, the system observes the normal processes and studies the regular and expected behaviors in the organization, so that risky deviations can later be detected and notified. The discovery process is mainly automatic, but enables human intervention and guidance, including adding, deleting, replacing and modifying activities, so that the result reflects in an optimal way the processes and behaviors within the organization. The products of the discovery stage are fed back into the system, so that the performance in the on-going stage is enhanced and reflects more accurately the activities taking place within the organization. The discovery process preferably continues during the on-going usage, and thus the system continues to constantly update, enhance, and refine the detection of actions taking place within the organization. The discovery mode of the system identifies best practices relevant to the organization, through identifying basic activities out of the acquired actions, deducing composite activities from the basic ones, and defining a metrics for the deduced activities. Each step in the process is preferably monitored by a human who is familiar with the organization. The products of the discovery process can be used with any process management system, and are not limited to being used with the system employed during the discovery stage. The present application claims priority from U.S. patent application Ser. No. 10/551,353, titled APPARATUS AND METHODS FOR PROCESS AND PROJECT MANAGEMENT AND CONTROL, filed 28 Sep. 2005, and from PCT International patent application serial number PCT/IL2005/000833 titled APPARATUS AND METHODS FOR PROCESS AND PROJECT MANAGEMENT AND CONTROL, filed 4 Aug. 2005, both applications incorporated herein by reference.

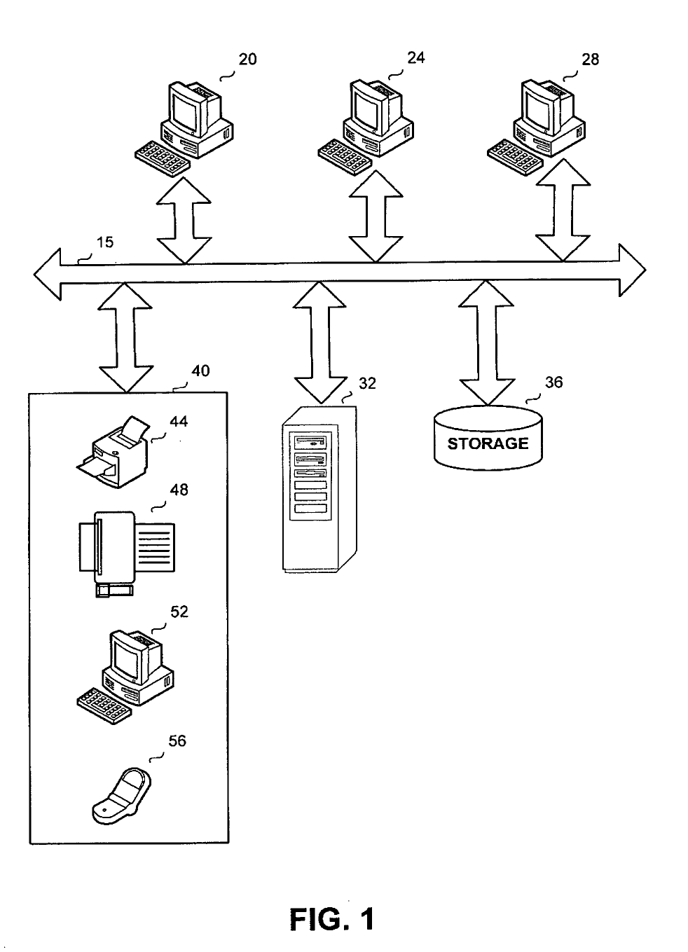

Referring now to FIG. 1, showing a typical environment in which the disclosed apparatus is used. A typical environment is an organization, employing multiple workers and performing multiple-person projects, such as developing new products, issuing new versions, fixing bugs, creating work plans, leading an organizational change, or the like. The typical computational environment of such organization comprises a network 15, multiple work stations 20, 24, 28, each work station being used by one or more users, and additional components, such as one or more mail servers, backup servers or the like. Preferably, the environment further comprises a server 32 and a storage unit 36. In addition, the environment comprises one or more general-purpose or specific devices for receiving an alert when a risk level assessed by the system exceeds a predetermined threshold. The general-purpose devices can include, but are not limited to a printer to which notifications can be sent, a fax machine 44, a computer 52 able of receiving e-mails or otherwise being notified, a cellular phone 56 receiving either vocal or textual messages, and the like. The disclosed invention is preferably implemented as a client-server solution, wherein the client part, including a user interface, is executed by workstations 20, 24, 28 and others, and the server part is executed on server 32. Workstations 20, 24, 28, and server 32 are preferably computing platforms such as a personal computer, a mainframe computer, or any other type of computing platform that is provisioned with a memory device (not shown), a CPU or microprocessor device, and several I/O ports (not shown). Alternatively, the server can be a DSP chip, an ASIC device storing the commands and data necessary to execute the methods of the present invention, or the like. Workstations 20, 24, 28, and server 32 can further include a storage device (not shown), storing the relevant applications. The applications are sets of logically inter-related computer programs and associated data structures that interact to detect, reduce or notify about risks. The methods of the disclosed invention are flexible, the relevant components implementing the methods of the disclosed invention can be split in various ways between the server and the clients, the server's tasks can be distributed among two or more servers, and additional variations are possible. Storage unit 36, storing the data relevant to the organization can be a part of server 32, of any one or more of workstations 20, 24 or 28, a dedicated storage device or a general purpose storage device used for other purposes as well. The storage device can be magnetic tape, a magnetic disc, an optical disc, a laser disc, a mass-storage device, or the like.

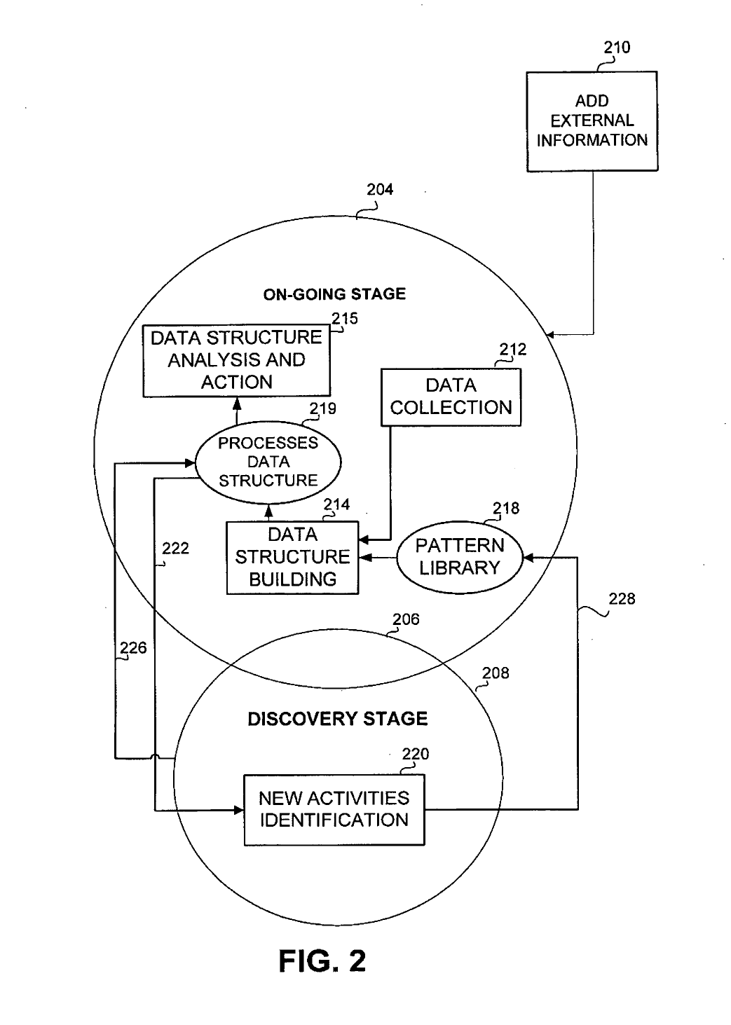

Referring now to FIG. 2, representing an overall scheme showing the relation between the two principal stages of a process management system, the discovery stage, and the on-going stage. On-going stage 204, is a working state of a workflow or process management system. It will be appreciated by a person skilled in the art that at the beginning of this stage, the system works only with off-the-shelf knowledge about the organization, such as knowledge about similar organizations, rather than a tailored solution. It will also be appreciated that a certain period of time during which the process management system is employed in an on-going stage is required in order to collect information for the discovery stage. Alternatively, otherwise collected data should be supplied to the system for adaptation. During on-going stage 204 an overall picture of the actions occurring within the organization is acquired, and activities relevant for the organization are determined or created. On-going stage 204 comprises three main steps: data collection step 212, data structure building step 214, and data structure analysis and action step 215, in which the process management system provides output to the environment about risks, deadlines, processes not performed according to guidelines or the like. Step 215 is detailed in the abovementioned International patent application. During data collection step 212, data relevant to activities taking place within the organization is imported from sources such as e-mail, web browsing, chat, instant messages or the like. At step 214 a data structure, for example a process data structure 219 such as a process map, describing the activities within the organization and their interrelationships is constructed or updated, according to the collected data. Data structure building step 214 uses activities imported on collection step 212 as captured from the organization, as well as a pattern library 218 which provides insight to generic and industry-specific processes and their relationships. In addition to data gathered from the environment, on going stage 204 optionally uses external information fed into the system at step 210, including for example standard activities or behaviors.

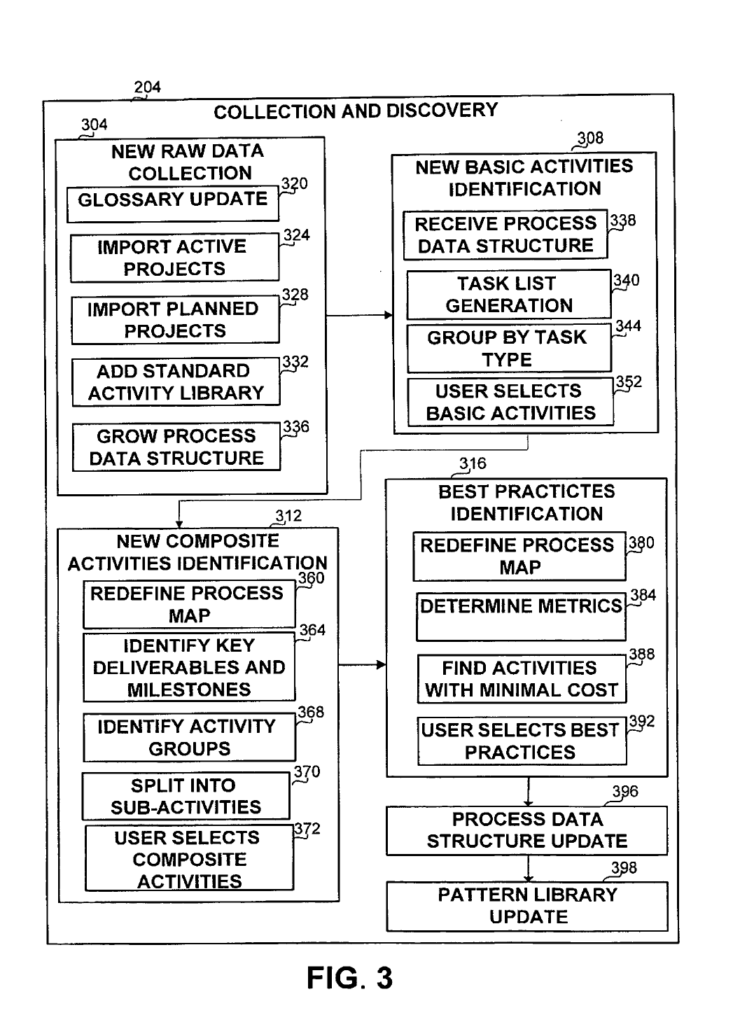

Either simultaneously with on-going stage 204, or off-line, discovery stage 208 takes place. Discovery stage 208 comprises new pattern identification step 220, which receives as input 222 process data structure 219, which is the output of data structure building step 214, to identify new, customer specific activities. In a preferred embodiment, the data structure is a map and the activities are expressed as patterns. The (new discovered?) patterns, or otherwise expressed activities are fed back 228 into pattern library 218 and are used to enhance steps 214 and 215 of on-going stage 204. In addition, in a preferred embodiment the process map as enhanced by discovery stage 208 is fed 226 into process map 219, thus providing better analysis of the current processes within the organization. In a preferred embodiment, discovery stage 208 is preferably active simultaneously with on-going step 204, as indicated by area 206, by on-going step 204 supplying 222 information about ongoing activities and behaviors to discovery step 208, and discovery step 208 supplying 226 new activities, new processes and additional newly-acquired information, possibly expressed as patterns to on-going step 204. Alternatively, discovery step 208 is active off-line as a separate process, possibly performed in a dedicated environment. The output of discovery step 208, comprising patterns of activities taking place within the organization, is optionally used by on-going step 204 for on going process management as described in US patent application titled APPARATUS AND METHODS FOR PROCESS AND PROJECT MANAGEMENT AND CONTROL, filed 28 Sep. 2005. In an alternative embodiment, the output of discovery step 208 may be used by any process and workflow management system, and not necessarily the system employed at on-going stage 204 ( [symbol] ). Steps 212, 214 and 220 are further detailed in association with FIG. 3 below. Steps 212 and 214 are detailed mainly in association with new raw data collection step 304 of FIG. 3, while pattern identification step 220 is executed at multiple steps of FIG. 3.

Reference is now made to FIG. 3, which is a flowchart showing the sub-steps associated with data collection step 212, data structure building step 214, and discovery step 208 of FIG. 2. New raw data collection step 304 details data collection step 212 and data structure building step 214 of FIG. 2. Discovery step 208 of FIG. 2 is detailed in FIG. 3 by three major steps: new basic activities identification step 308, new composite activities identification step 312 and best practices identification step 316. Steps 304, 308, 312 and 316 are preferably executed at this order. However the order of the sub-steps within each step is less strict, and steps can be repeated, omitted, or performed before or after other steps. New raw data collection step 304 comprises a glossary update step 320, wherein terminology used within the organization and not identified by standard pattern library is introduced to the system, and preferably connected to generic terms used within the system, such as relating to SRS “software requirement specification” and to “requirement document” or the like. At step 324, projects active within the organization are imported into the system, by importing one or more actions associated with the project, such that the system is aware of on-going projects and will create the relevant activities for them in the map. The actions associated with the projects are mainly imported into the system through the usage of e-mail messages marked accordingly. Such projects can be, for example, a software update, a new model of a device, or the like. At step 328, actions associated with planned projects are imported, so that relevant planned activities are created for them, as well. At step 332, one or more standard activities libraries are fed into the system, so that standard actions, for example writing a requirements document is perceived by the system as such, without having to deduce all common activities. The library can be a general multi-purpose library, or a library specifically constructed for the organization or for organizations of similar nature. At step 336, the standard library and collected data are used to create or grow a process data structure of the activities taking place, or planned to take place within the organization. Data structure growing step 336 is associated with data structure building step 214 of FIG. 2. The process of building the data structure depends on the specific data structure. For example, the procedure of building a process map representing the activities is described in detail in US patent application titled APPARATUS AND METHODS FOR PROCESS AND PROJECT MANAGEMENT AND CONTROL, filed 28 Sep. 2005. Once the process map is grown, new activities are identified within the process map, based on identifying the flow of actions, relevant documents and other deliverables such as executable files, configuration files, resources or other deliverables between participants, and an activity hierarchy. The activities are identified by a new basic activities identification step 308 and new composite activities identification step 312. New basic activities identification step 308 preferably starts after the system collected data as described in association with new raw data collection step 304, and significant amount of actions has been collected. At step 308, the process data structure generated at step 304 is analyzed for new basic activities describing individual tasks. The recognized new activities define new task types and include, for example: a generic task type, such as “bug fix”, task deliverables and deliverables types, such as a fixed program and an accompanying document and materials, such as documents, used in those activities. The execution of step 308 comprises the following sub-steps: at step 338, the process data structure as grown at step 336 is received, and at step 340, a list of all tasks and related data is generated out of the process data structure. At step 344, the tasks, each task having a generic task type as entered by the executer or complemented by the system in the process of data structure building, are grouped according to the task type. The task type is preferably associated with an activity. Alternatively tasks can be grouped according to the task's owner or according to the basic activities used during data structure growing step 336. At step 352, a set or sub-set of basic activities, preferably associated with customer-specific task groups, is selected by a user to be transformed into a pattern and added to the pattern library as detailed below in association with step 398. This step is preferably performed manually by a user with detailed understanding of the domain and the occurring activities. At step 312, new composite activities which represent repeatable flow of basic activities are recognized. The basic and composite activities later serve as building blocks for real-world process definition of processes within the organization. Step 312 comprises the following sub steps: at step 360, the process data structure as generated at step 336 is redefined in terms of the basic activities identified at step 308. At step 364 key deliverables of individuals or groups are identified mainly by being accessed by multiple participants, especially participants from a different organizational unit than the unit in which the deliverable was created, or by customers. Milestones, which are often described by a formal release of one or more deliverables, are thus identified by releases of such key deliverables. At step 368 the method identifies groups of identical or similar activities used to achieve the milestones or produce the key deliverables. The groups of activities are composite activities, which represent processes or process components. At step 370, similar sub-activities occurring in different activities are defined as independent activities. At step 372, he identified composite activities are presented to a user, who selects among them the ones which are relevant for the organization. The activities are later transformed into patterns and added to the pattern list at step 398. At step 316, best practices, as defined within the organization are recognized. At step 380, the process data structure built at step 336, and redefined at step 360, is redefined again, to reflect also composite activities identified at step 312. At step 384, metrics representing execution time and cost are determined for each basic or composite activity, based on the activity itself and on the association of the basic activity to a composite activity. At step 388, activities involved in process instances, having an optimal cost, as identified at step 384 are identified. At step 392, the activities identified at step 388 are transferred to selection by a user. The approved activities are defined to represent best practices of the organization. As can be seen, each of steps 308, 312 and 316, comprises automatic steps of recognition of activities, followed by a step of human selection and approval. The combination of automatic and manual steps maximizes efficiency on one hand, while producing the most appropriate results for the organization on the other hand. The method further comprises a step of updating the process data structure 396, for example the process map of the organization, upon which on-going step 204 of FIG. 2 later takes place. The method comprises also a pattern library update step 398, during which the basic and composite activities are translated into patterns and are fed back into pattern library 218 of FIG. 2. At the end of discovery step 204 of FIG. 2, the method produced a process data structure comprising one or more activities relevant to the organization which are later identified among the on going activities occurring within the organization, and are used for process management, risk analysis and process completion as described in detail in US patent application titled APPARATUS AND METHODS FOR PROCESS AND PROJECT MANAGEMENT AND CONTROL, filed 28 Sep. 2005. It will be appreciated by a person of ordinary skill in the art that some or all of the presented steps can be omitted, repeated, occur at different order, or include additional steps. The following examples illustrate the process. The first example relates to a telecom company developing a new product to be marketed in multiple countries. During the development process, a new requirement is posed to test the device against a specific regulation within a certain country. The test is to be carried out in a governmental lab, and has to be scheduled in advance, wherein all relevant documentation has to be submitted prior to the planned testing. The project manager adds the requirement to the system and defines the major activities, including scheduling an internal compliance test, scheduling a public test, creating the documentation set, and obtaining the certificate. Most of the activity types are already known to the system and therefore appear in the pattern library. However, creating the relevant documentation set will be initially by default defined as a generic task. The discovery stage will identify that that creating the documentation set is a new basic activity, and will also identify a new deliverable for the whole process—the required compliance certificate. The discovery stage will therefore identify a new composite pattern for the particular compliance certification process based on the activities carried out on the process map. Since the pattern was identified based on a one-time occurrence, the system will notify a human operator for approval to add this pattern to the pattern library. If such approval is granted, the next time such certificate needs to be issued, a system that receives the update pattern library will recognize and control this pattern.

A second example relates to a system integrator trying to organize the operations as the company matures and grows. The system is deployed for a period of time, typically between a few weeks and a few months and information about the on going activities is gathered. Then, when the discovery stage is activated, it groups all the activities based on a name or a type as provided by a user, as well as on the generated deliverables and parent activities. In the composite patterns identification step, when a certain activity occurs multiple times, the system checks the statistics for eliminating performance fluctuations. If multiple patterns are found to produce the same deliverables, they are compared for efficiency using a calculated metrics. The resulting patterns and best practices can then be used in an on-going manner by any workflow management system, wherein the system will steer a user towards the use of the best practice patterns.

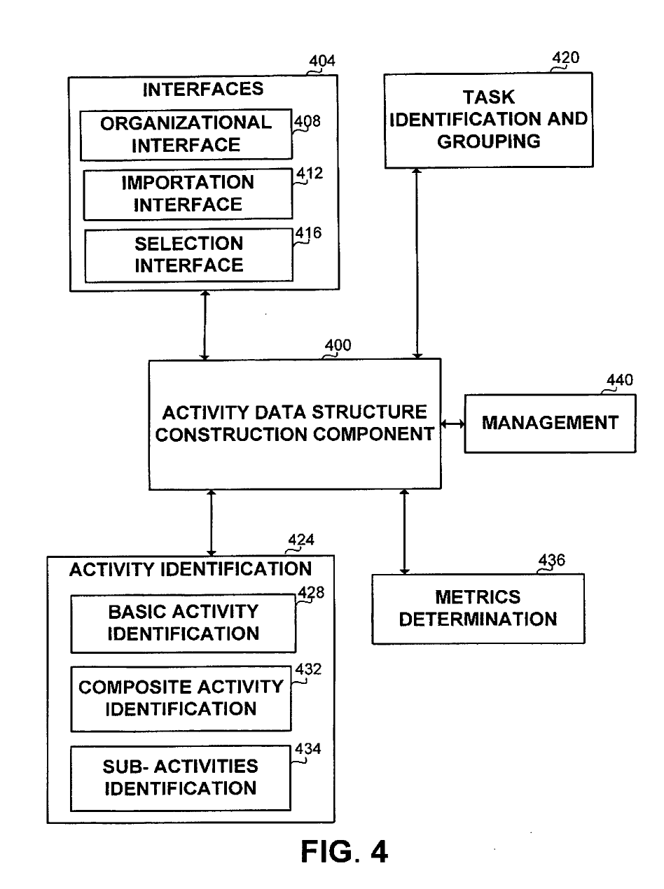

Referring now to FIG. 4, showing a block diagram of the main components in an apparatus designed to perform the process discovery step of the disclosed invention. Each component is preferably a module comprising computer instructions for performing one or more activities. It will be appreciated by a person skilled in the art that the described block diagram is merely one possibility, and other implementations, including different division of the functionalities into components can be designed and implemented. The core of the system is activity data structure construction component 400. Component 400 is responsible for maintaining all the data structures which represent knowledge about processes and activities within the organization, as fed into the system, identified automatically or constructed at any of the discovery steps. In a preferred embodiment, the activity data structure is a process map, comprising one or more patterns representing activities occurring in the organization. Each of the other main components of the apparatus as detailed below, communicate bi-directionally with activity data structure construction component 400, in order to provide data or perform additional processing on the constructed activities. The main input relating to the activities is obtained from interfaces component 404. Interfaces component 404 comprises an organizational interface component 408 responsible for interfacing with systems used within the organization, such as e-mail, file servers and others. Interfaces component 404 further comprises an importation interface 412, through which external data, such as activities definition, glossary and other data is imported into the system to be used in building the knowledge base of the processes within the organization. Yet another interface is selection interface 416, which is used to present a user with multiple options, including for example the basic activities presented at step 352, the composite activities presented at step 372 and the best practices presented at step 392. Selection interface 416 is further responsible for receiving from the user input regarding which ones of the presented possibilities should indeed be incorporated in the constructed activities structure. The apparatus further comprises a task identification and grouping component 420, responsible for identifying and grouping tasks and task types, for example by their products, such as deliverables. Yet another component communicating with activities construction component 400 is activity identification component 424. In a preferred embodiment, activity identification component 424 comprises basic activities identification component 428, responsible for recognizing basic activities within the organization, composite activities identification component 432, responsible for recognizing composite activities, which comprises basic activities, and sub-activities identification component 434, responsible for identifying identical or similar sub-activities occurring within different activities. The apparatus further comprises a metrics determination component 436 for determining the metrics associated with each activity. The specific implementation of the abovementioned components is dependent on the specific data representation chosen for implementing the activities within the organization. The flow of data and order of activation of the various components depends mainly on the method employed for representing the processes and activities. For example, when the representation involves a map comprising nodes and arcs in which patterns are recognized, the components will be implemented as graph-handling routines. The flow of data and order of activation of the various components is determined and managed by management component 440, responsible for activating the other components according to the guidelines described in association with FIG. 3 above.

It will be appreciated by persons skilled in the art that the present invention is not limited to what has been particularly shown and described hereinabove. Rather the scope of the present invention is defined only by the claims which follow.

What is claimed is:

1. A method for discovering an at least one activity or an at least one process within an organization, the method comprising the steps of:
receiving an at least one process map, the process map comprising an at least one action associated with an at least one active project or with an at least one planned project; and
identifying an at least one activity or an at least one process from the at least one process map.

2. The method of claim 1 further comprising a step of updating an at least one pattern library based on the at least one activity or the at least one process.

3. The method of claim 1 further comprising a step of updating the at least one process map.

4. The method of claim 1 wherein the at least one action is created from an e-mail message.

5. The method of claim 1 wherein the at least one action is created from a user reporting of the at least one action.

6. The method of claim 1 wherein the at least one action is created from an operation performed in a quality center, or in a requirements management system, or in an update in a spreadsheet.

7. The method of claim 1 wherein the at least one activity is presented as an at least one pattern.

8. The method of claim 1 wherein the at least one activity is a basic activity.

9. The method of claim 1 wherein identifying the at least one activity or the at least one process comprises the steps of:
generating a task list comprising an at least one task, the at least one task having a task type and representing an activity;
grouping the at least one task according to the task type into an at least one group, said group representing the activity; and
selecting an at least one group by a user.

10. The method of claim 1 wherein the at least one activity is a composite activity.

11. The method of claim 1 further comprising a step of identifying an at least one key deliverable, or an at least one milestone.

12. The method of claim 1 further comprising a step of identifying an at least one activity group.

13. The method of claim 12 further comprising a step of splitting an at least one activity group into at least two activities.

14. The method of claim 1 further comprising a step of selecting an at least one activity by a user from a list of activities.

15. The method of claim 1 further comprising a step of adding a standard activity library.

16. The method of claim 1 further comprising the steps of:
determining a metrics for associating a cost with an at least one practice; and
identifying an at least one practice having an optimal cost within the organization.

17. The method of claim 1 further comprising an on-going stage for constructing, controlling or managing an at least one process based on the at least one process map.

18. The method of claim 1 when used simultaneously with or after the on-going stage of claim 17.

19. The method of claim 17 wherein the on-going stage uses the process map.

20. An apparatus for discovering an at least one activity or an at least one process within an organization, the apparatus comprising:
an at least one interface component;
an at least one activity identification component;
an at least one management component; and
an activity data structure construction component.

21. The apparatus of claim 20 further comprising a metrics determination component.

22. The apparatus of claim 20 further comprising a task identification and grouping component.

23. The apparatus of claim 20 wherein the interface component is an organizational interface component.

24. The apparatus of claim 23 wherein the organizational interface component captures information from an at least one e-mail message.

25. The apparatus of claim 23 wherein the data structure is a process map.

26. The apparatus of claim 25 wherein the process map comprises an at least one pattern.

27. A computer readable storage medium containing a set of instructions for a general purpose computer, the set of instructions comprising:
receiving an at least one process map, the process map comprising an at least one action associated with an at least one active project or with an at least one planned project; and
identifying an at least one activity or an at least one process from the at least one process map.
